(19) United States
(12) Patent Application Publication
(10) Pub. No.: US 2011/0250004 A1
(43) Pub. Date: Oct. 13, 2011

(54) Tubular Holder

(76) Inventor: Mei-Chang Chung, Hsinchu City (TW)

(21) Appl. No.: 13/081,215

(22) Filed: Apr. 6, 2011

(30) Foreign Application Priority Data
Apr. 9, 2010 (TW) 099206299

(51) Int. Cl. B43K 23/016

(52) U.S. Cl. 401/94

(57) ABSTRACT

A tubular holder includes: a tubular wall defining a hollow space adapted to receive an object, and having axially opposite rear and front open ends, and a through hole extending through the tubular wall between the rear and front open ends; a clamp disposed at an outer side of the tubular wall and having a resilient claw extending into the hollow space through the through hole; and a push member disposed movably in the hollow space for pushing the object forward and having a stop face on an outer surface of the push member, the stop face being able to abut against a free end of the resilient claw to prevent rearward movement of the push member so that the push member can move only in a forward direction.

### CROSS-REFERENCE TO RELATED APPLICATION

This application claims priority of Taiwanese application no. 099206299, filed on Apr. 9, 2010.

### BACKGROUND OF THE INVENTION

1. Field of the Invention

This invention relates to a tubular holder, more particularly to a tubular holder that is capable of holding adjustably a rod-shaped object, such as chalk.

2. Description of the Related Art

When a user, especially a teacher, uses chalk during teaching, the user's fingers and books or other teaching aids are likely to be stained with chalk dust. For preventing this drawback, in most cases, the chalk is installed in a chalk holder to avoid direct contact with the chalk. However, the conventional chalk holders cannot firmly clamp the chalk with a relatively short length, and two or more chalks cannot be simultaneously installed therein for a long-time use. Besides, in one type of the conventional chalk holders, a push member is not used to move the chalk to extend out of the chalk holder. For example, the chalk is clamped by the chalk holder after a portion of the chalk inside falls to extend out of the chalk holder by gravity, or after adjusting the portion of the chalk to extend out of the chalk holder by the fingers of the user. Therefore, the conventional chalk holders need further improvement in convenience during use.

### SUMMARY OF THE INVENTION

Therefore, an object of the present invention is to provide a tubular holder that can overcome the aforesaid drawbacks associated with the prior art.

According to one aspect of the present invention, a tubular holder comprises:

a tubular wall defining a hollow space adapted to receive an object, and having axially opposite rear and front open ends, and a through hole extending through the tubular wall between the rear and front open ends;

a clamp disposed at an outer side of the tubular wall and having a resilient claw extending into the hollow space through the through hole; and

a push member disposed movably in the hollow space for pushing the object forward and having a stop face on an outer surface of the push member, the stop face being able to abut against a free end of the resilient claw to prevent rearward movement of the push member so that the push member can move only in a forward direction.

According to another aspect of the present invention, a tubular holder comprises:

a tubular wall defining a hollow space adapted to receive an object, and having axially opposite rear and front open ends, and a plurality of through holes that are spaced apart from each other axially and angularly; and

a plurality of clamps disposed around the tubular wall and spaced apart axially from each other, each of the clamps having a ring disposed around the tubular wall, and a plurality of resilient claws projecting from the ring at angularly spaced apart positions and extending into the hollow space of the tubular wall through the through holes, respectively.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded view of the first preferred embodiment of a tubular holder according to the present invention;

FIG. 2 is a fragmentary perspective view of the preferred embodiment of the tubular holder according to the present invention in a use state;

FIG. 3 is a cross-sectional view of the preferred embodiment of the tubular holder according to the present invention; and

FIG. 4 is an exploded view of the second preferred embodiment of a tubular holder according to the present invention.

### DETAILED DESCRIPTION OF THE PREFERRED EMBODIMENTS

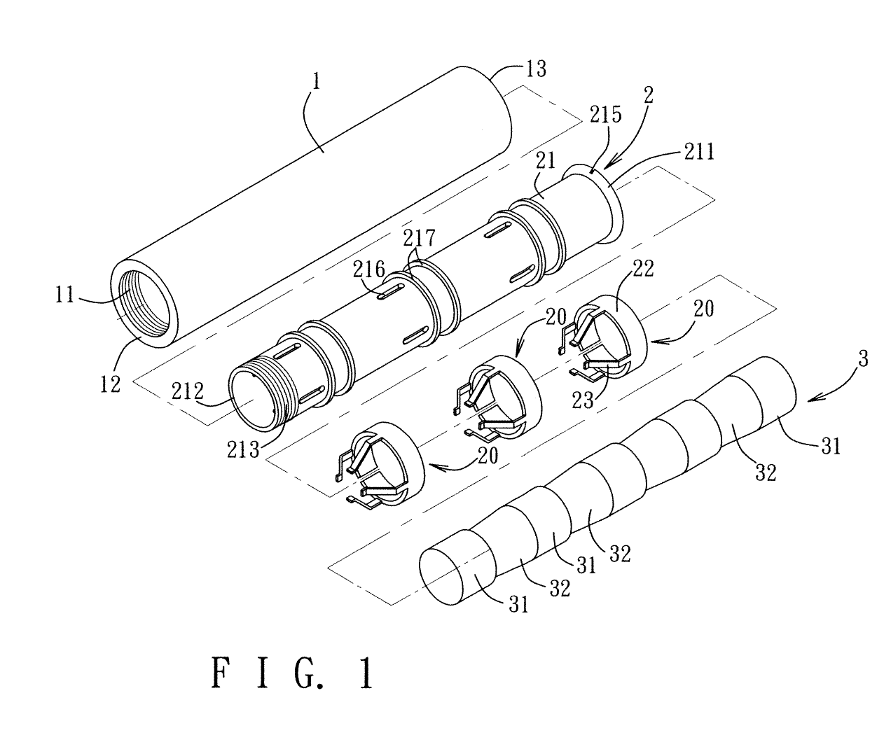

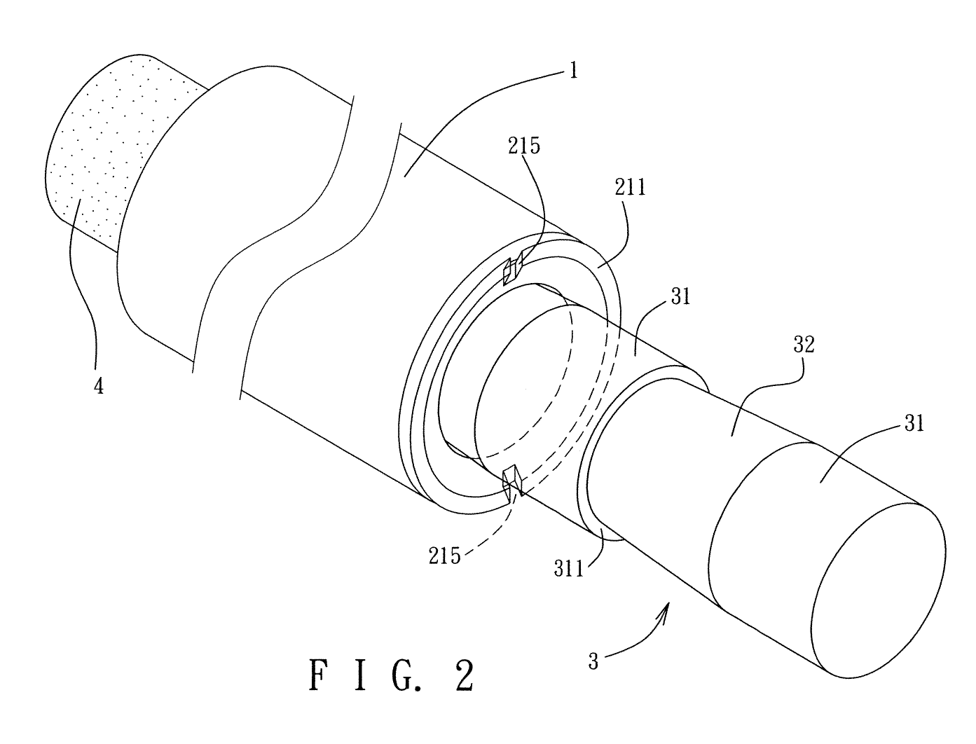

Referring to FIGS. 1 to 3, the first preferred embodiment of a tubular holder of this invention includes an outer tube 1, a tubular wall 2, a plurality of clamps 20, and a push member 3. In the preferred embodiment, three clamps 20 are included.

The outer tube 1 is disposed around the tubular wall 2, and has an inner thread 11 at a front end 12 thereof.

The tubular wall 2 defines a hollow space adapted to receive a rod-shaped object, for example, a chalk 4. The tubular wall 2 has axially opposite rear and front open ends 211, 212 and a plurality of through holes 216. The front open end 212 of the tubular wall 2 has an outer thread 213 engaged to the inner thread 11 of the outer tube 1. The rear open end 211 of the tubular wall 2 flares outwardly and extends out of a rear end 13 of the outer tube 1. In addition, the rear open end 211 of the tubular wall 2 has an end face formed with two diametrically opposite recesses 215, by which the tubular wall 2 is rotatable inside the outer tube 1 to engage the outer thread 213 to the inner thread 11 using a tool (not shown). The through holes 216 are spaced apart from each other axially and angularly, and extend through the tubular wall 2 between the rear and front open ends 211, 212.

The clamps 20 are disposed at an outer side of the tubular wall 2 and are spaced apart axially from each other. Each of the clamps 20 has a ring 22 disposed around the tubular wall 2 and between the outer tube 1 and the tubular wall 2, and a plurality of resilient claws 23 projecting axially and inclinedly inward from the ring 22 at angularly spaced apart positions and extending into the hollow space of the tubular wall through the through holes 216, respectively. Preferably, each ring 22 is a C-ring, and each clamp has a plurality of resilient claws 23 that are equiangularly spaced apart. In this embodiment, each clamp 20 has four resilient claws 23. The resilient claws 23 of the clamp 20 are used for clamping the chalk 4 or for engaging the push member 3.

For each clamp 20, an outer surface 21 of the tubular wall 2 is formed with a pair of annular protrusions 217 disposed respectively on two opposite sides of the ring 22 to prevent the ring 22 from displacement.

The push member 3 is disposed movably in the hollow space for pushing the object (i.e., the chalk 4) forward. The push member 3 has a plurality of stop faces on an outer surface thereof. Each of the stop faces is able to abut against a free end of one of the resilient claws 23 to prevent rearward movement of the push member 3 so that the push member 3 can move only in a forward direction.

In the preferred embodiment, the push member 3 includes a plurality of cylindrical first sections 31, a plurality of truncated cone-shaped second sections 32, and a plurality of shoulder faces 311 to serve as the stop faces. The cylindrical first sections 31 have a constant cross section. The truncated cone-shaped second sections 32 alternate with the first sections 31. Each of the shoulder faces 311 is formed on one of the first sections 31 adjacent to one of the second sections 32. Each of the resilient claws 23 is able to engage one of the shoulder faces 311 to prevent rearward movement of the push member 3 so that the push member 3 can move only in a forward direction. Accordingly, when the push member 3 moves toward the front open end 212, the resilient claws 23 of each clamp 20 can be radially expanded by the corresponding first section 31. After each of the first sections 31 passes by the resilient claws 23 of one of the clamps 20, the resilient claws 23 retract and engage one of the shoulder faces 311 to prevent rearward movement of the push member 3. The push member 3 has an outer surface confronting an inner surface of the tubular wall 2. The push member 3 may be an elongate solid body or an elongate hollow body that has two opposite closed ends, and that is lightweight and easy to operate.

In use, the chalk 4 is installed from the rear open end 211 of the tubular wall 2, followed by installing the push member 3. When adjusting an extension length of the chalk 4 out of the tubular holder, the chalk 4 can be pushed to extend out of the tubular wall 2 stepwise by virtue of the combination of the push member 3 and the resilient claws 23. Accordingly, the chalk 4 can be prevented from breaking due to an overly long extension length of the chalk 4 out of the tubular wall 2.

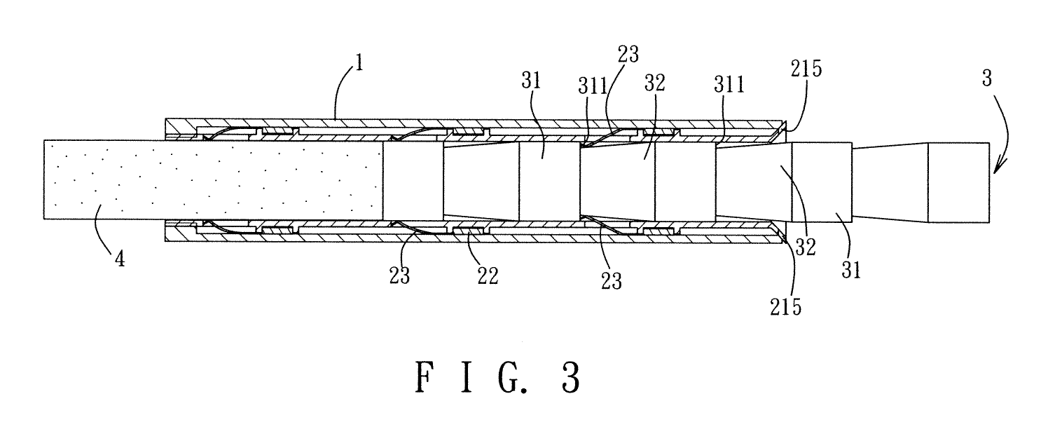

It should be noted that the sizes of the outer tube 1, the tubular wall 2, and the push member 3 can be varied based on users' requirements. The numbers of the clamps 20, the through holes 216, the annular protrusions 217, the resilient claws 23, and the shoulder faces 311 may also be varied. Besides, in this embodiment, only one chalk 4 and one push member 3 are exemplified to be installed in the tubular wall 2 as shown in FIG. 3. However, in other embodiments, more than one of the object and more than one of the push member 3 may be installed in the tubular wall 2. For example, after inserting one chalk 4 and a relatively short push member 3, another chalk 4 and a relatively long push member 3 may be further inserted into the tubular wall 2, or two chalks 4 may be successively inserted in the tubular wall 2, followed by inserting the push member 3.

With the provision of the tubular holder of this invention, the chalk 4 can be firmly held thereinside, and can be extended out stepwise.

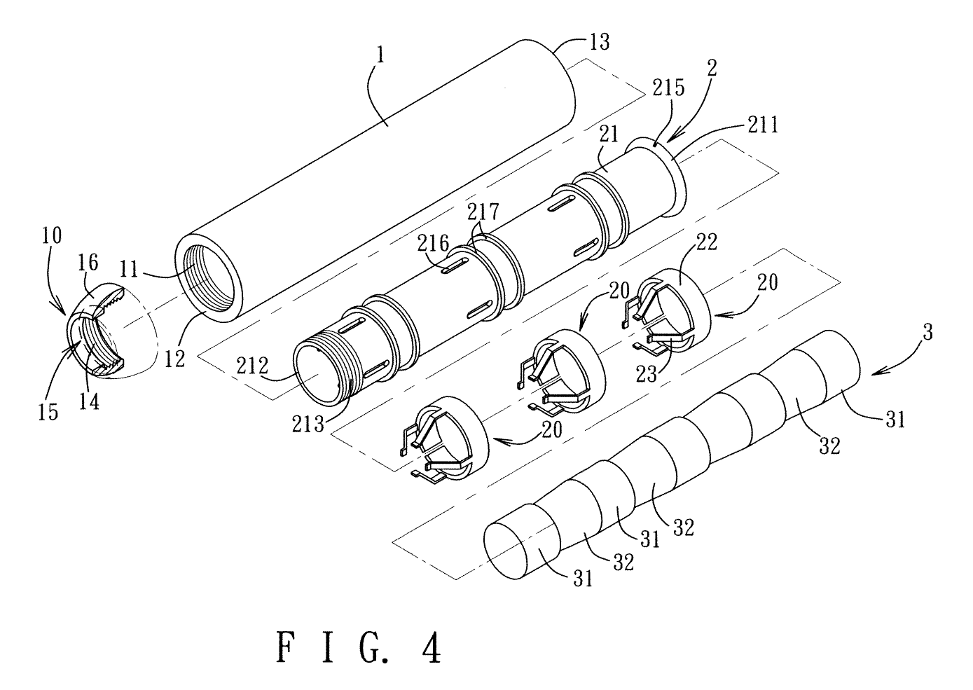

FIG. 4 illustrates the second preferred embodiment of the tubular holder of this invention. The second embodiment differs from the first embodiment in having additionally a hollow cone body 10 disposed in front of the outer tube 1. The hollow cone body 10 has an inner surface 15 and an outer surface 16 surrounding the inner surface 15. The inner surface 15 has an inner thread 14 engaged to the outer thread 213 of the tubular wall 2 in proximity to the outer tube 1. With the hollow cone body 10, the second preferred embodiment of the tubular holder according to this invention has a streamlined outline.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A tubular holder, comprising:
a tubular wall defining a hollow space adapted to receive an object, and having axially opposite rear and front open ends, and a through hole extending through said tubular wall between said rear and front open ends;
a clamp disposed at an outer side of said tubular wall and having a resilient claw extending into said hollow space through said through hole; and
a push member disposed movably in said hollow space for pushing the object forward and having a stop face on an outer surface of said push member, said stop face being able to abut against a free end of said resilient claw to prevent rearward movement of said push member so that said push member can move only in a forward direction.

2. The tubular holder of claim 1, wherein said clamp further has a ring disposed around said tubular wall, said resilient claw projecting from said ring and extending into said hollow space.

3. The tubular holder of claim 2, wherein an outer surface of said tubular wall is formed with a pair of annular protrusions disposed respectively on two opposite sides of said ring to prevent said ring from displacement.

4. The tubular holder of claim 2, wherein said ring is a C-ring.

5. The tubular holder of claim 2, further comprising an outer tube disposed around said tubular wall and having an inner thread at a front end thereof, said front open end of said tubular wall having an outer thread engaged to said inner thread, said ring being disposed between said outer tube and said tubular wall.

6. The tubular holder of claim 5, wherein said rear open end of said tubular wall has an end face formed with two diametrically opposite recesses.

7. The tubular holder of claim 5, wherein said rear open end of said tubular wall flares outwardly and extends out of a rear end of said outer tube.

8. The tubular holder of claim 5, further comprising a hollow cone body disposed in front of said outer tube, said hollow cone body having an inner surface and an outer surface surrounding said inner surface, said inner surface having an inner thread engaged to said outer thread of said tubular wall in proximity to said outer tube.

9. The tubular holder of claim 1, wherein said push member is an elongate hollow body that has two opposite closed ends.

10. The tubular holder of claim 1, wherein said push member is an elongate solid body.

11. The tubular holder of claim 1, wherein said push member is an elongate body that has an outer surface confronting an inner surface of said tubular wall, said stop face being a shoulder face formed on said outer surface of said elongate body to engage said free end of said resilient claw.

12. A tubular holder, comprising:
a tubular wall defining a hollow space adapted to receive an object, and having axially opposite rear and front open ends, and a plurality of through holes that are spaced apart from each other axially and angularly; and
a plurality of clamps disposed around said tubular wall and spaced apart axially from each other, each of said clamps having a ring disposed around said tubular wall, and a plurality of resilient claws projecting from said ring at angularly spaced apart positions and extending into said hollow space of said tubular wall through said through holes, respectively.

13. The tubular holder of claim 12, further comprising a push member disposed movably in said hollow space for pushing the object forward, and including a plurality of first sections that have a constant cross section, a plurality of truncated cone-shaped second sections that alternate with said first sections, and a plurality of shoulder faces each formed on one of said first sections adjacent to one of said second sections, each of said resilient claws being able to engage one of said shoulder faces to prevent rearward movement of said push member so that said push member can move only in a forward direction.
